(19) United States
(12) Patent Application Publication
(10) Pub. No.: US 2010/0080949 A1
(43) Pub. Date: Apr. 1, 2010

(54) Aerogel Composites with Complex Geometries

(75) Inventors: Duan Li Ou, Northborough, MA (US); Shannon O. White, Hudson, MA (US)

Correspondence Address: ASPEN AEROGELS INC.;IP DEPARTMENT, 30 FORBES ROAD, BLDG. B, NORTHBOROUGH, MA, 01532, US

(73) Assignee: ASPEN AEROGELS,INC., Northborough, MA (US)

(21) Appl. No.: 11/458,357

(22) Filed: Jul. 18, 2006

Related U.S. Application Data
(60) Provisional application No. 60/700,084, filed on Jul. 18, 2005.

(51) Int. Cl. C08J 9/00; C08L 33/12; C08L 83/04; C08L 9/00; C08L 71/00; C08L 75/04; B32B 3/02

(52) U.S. Cl. 428/80; 521/50; 521/149; 521/154; 521/150; 521/189; 521/170; 521/92; 264/299

(57) ABSTRACT

The present disclosure describes aerogel composites comprising organic-inorganic hybrid aerogel particulates and binders, in particular systems with aerogel and binders covalently bonded along with methods for preparing the same. Said composites can be formed into articles having complex geometries.

### CROSS-REFERENCES TO RELATED APPLICATIONS

This application claims benefit of priority to U.S. Provisional Patent Application Ser. No. 60/700,084 filed on Jul. 18, 2005; the contents of which are hereby incorporated by reference as if fully set forth.

### STATEMENT REGARDING FEDERALLY SPONSORED RESEARCH OR DEVELOPMENT

This invention was partially made with Government support under Contract NNK05OA31C awarded by the NASA. The Government may have certain rights in parts of this invention.

### SUMMARY OF THE INVENTION

Compositions comprising organic-inorganic hybrid aerogel particulates and a binder, wherein said binder comprises components that are of same family as at least an organic component of said hybrid aerogel particulates are described. The compositions may have at least one component of said aerogel particulates forms at least one covalent bond with said binder. The binder may be polymers, monomers, oligomers or a combination thereof. The binder may include a surfactant. The binder may be an emulsion, a suspension or a solution. The binder or polymeric part of the binder may be polymethylmethacrylate, polybutylmethacrylate, polyethylmethacrylate, polypropylmethacrylate, poly(2-hydroxyethyl-methacrylate), poly(2 hydroxypropylmethacrylate), poly(hexafluorobutyl-methacrylate), poly(hexafluoroisopropylmethacrylate), polydimethylsiloxane, polyoxyalkylene, polyurea, polybutadiene, polyurethanepolyoxypropylene, polyoxypropylene-copolyoxyethylene or mixtures thereof. These compositions may have at least a covalent bond between the aerogel particles and the binder comprises an acrylic moiety, siloxane moiety, urea moiety, ester moiety or a combination thereof. Such attachemnst or covalent bonding may be through polymethyl methacrylate chains. The aerogel particulates may have an average size of greater than about 0.5 mm and in another embodiment the average size may be less than about 0.5 mm. The inorganic component of the aerogel may be a metal oxide and in particular it could be silica, titania, zirconia, alumina, hafnia, yttria, ceria, carbides, nitrides and any combination thereof. Additionally, a trialkoxysilyl group may be attached to the organic component of hybrid aerogel. The binder may be in a nanoparticulate polymer form. The thermal conductivity of the compositions may be less than about 30 mW/mK, and preferably less than about 19 mW/mK. The compositions may have densities of less than about 0.3 g/cm³, optionally less than about 0.15 g/cm³.

The composition may further comprise infrared opacifiers, infrared reflectors, infrared absorbers, fire retardants, antimicrobial agents, antifungal agents, pigments, catalysts and smoke suppressors. Additionally, it may include fibers, optionally in the form of chopped fibers, batting, or lofty batting. A shaped article may be prepared out of any of the compositions disclosed in the present invention and they are optionally, in the general shape of clamshell, cylindrical, semicylindrical, semispherical or other complex geometry.

The articles can be bent up to 45 degrees without fracture and optionally bent up to 90 degress without fracture. The article may further have a tensile strength of at least 25 psi. In yet another composition of organic-inorganic hybrid aerogel particulates and a binder, at least one component of said aerogel particulates forms at least one covalent bond with said binder. Several methods of manufacture of an article are described comprising the steps of combining organic-inorganic hybrid aerogel particles with a binder; and curing said binder thereby forming an article, wherein at least one component of said aerogel particles forms at least one covalent bond with said binder. Other methods include combining organic-inorganic hybrid aerogel particles with a binder; and curing said binder thereby forming an article, wherein said binder comprises components that are of the same family as at least one organic component of said hybrid aerogel particulates. The binder comprises components that are of the same family as at least one organic component of said hybrid aerogel particles.

At least one component of said aerogel particles forms at least one covalent bond with said binder. The binder is an emulsion, a suspension or a solution. The binder comprises polymers, monomers, oligomers or combinations thereof. The binder may comprise a polymethylmethacrylate, polybutylmethacrylate, polyethylmethacrylate, polypropylmethacrylate,poly(2-hydroxyethyl-methacrylate),poly(2-hydroxypropylmethacrylate), poly(hexafluorobutyl-methacrylate), poly(hexafluoroisopropylmethacrylate), polydimethylsiloxane, polyoxyalkylene, polyurea, polybutadiene, polyoxypropylene, polyoxypropylene-copolyoxyethylene or mixtures thereof. The covalent bond comprises an acrylic moiety, siloxane moiety, urea moiety, ester moiety or a combination thereof and optionally comprise a polymethylmethacrylate chain. The aerogel particulates may have an average size of greater than about 0.5 mm and in another embodiment the average size may be less than about 0.5 mm. The inorganic component of the aerogel may be a metal oxide and in particular it could be silica, titania, zirconia, alumina, hafnia, yttria, ceria, carbides, nitrides and any combination thereof. Additionally, a trialkoxysilyl group may be attached to the organic component of hybrid aerogel. The binder may be in a nanoparticulate polymer form. The thermal conductivity of the compositions may be less than about 30 mW/mK, and preferably less than about 19 mW/mK. The compositions may have densities of less than about 0.3 g/cm³, optionally less than about 0.15 g/cm³. The composition may further comprise infrared opacifiers, infrared reflectors, infrared absorbers, fire retardants, antimicrobial agents, antifungal agents, pigments, catalysts and smoke suppressors. Additionally, it may include fibers, optionally in the form of chopped fibers, batting, or lofty batting.

The curing of the compositions may be performed at an elevated temperature, perhaps between 40° C. and 100° C. and preferably between 50° and 60° C. Methods of applying the compositions of several embodiments of the present invention on to a surface by spraying said composition onto said surface are also disclosed. Methods for forming the compositions into a complex geometry are disclosed wherein an embodiment, casting is performed to shape the articles.

This invention provides an aerogel-based composite comprising organic-inorganic hybrid aerogel particles and a binder preferably of polymeric nature. This aerogel/binder composite is moldable to three dimensional structures having complex shapes. Such shapes include, but are not limited to, panels, clamshells, and honeycomb structures. Further, the aerogel/binder mixture can optionally be sprayed to form films and coatings.

The preferred organic/inorganic hybrid aerogel beads are PMMA/silica hybrid aerogel beads. The preferred polymeric binder is a multicomponent polymethacrylate microemulsion. The aerogel /binder composites prepared accordingly can be cast into molds with the desired size and shape then cured at elevated temperatures to form rigid insulation components.

### DESCRIPTION OF THE DRAWINGS

FIG. 1 is a schematic illustration of the formation of aerogel particulate composites from PMMA/silica hybrid aerogel beads and a PMMA microemulsion.

FIG. 2 illustrates of the formation of a PMMA microemulsion.

FIG. 3 is a view of the aerogel particulate composite, derived from hybrid aerogel beads/microemulsion binder, under flexural test.

FIG. 4 is a clamshell insulation component prepared with the aerogel particulate composite.

FIG. 5 is a honeycomb insulation component derived from the aerogel particulate composite.

### DESCRIPTION

Aerogels are materials prepared by replacing the liquid solvent in pores of a gel with air and without substantially altering the network structure of the volume of the gel body. Supercritical and sub-critical fluid extraction technologies are commonly used to extract the solvent from the gel without causing the pores in the gel to collapse. This material was first made by Kistler in 1931 [S. S. Kistler, Nature, 1931, 127, 764]. The name aerogel describes a class of structures rather than a specific material. A variety of different aerogel compositions are known and could be inorganic, organic or inorganic/organic hybrids. Inorganic aerogels are generally based on metal alkoxides and include materials such as silica [S. S. Kistler, Nature, 1931, 127, 764], various carbides[C. I. Merzbacher et al, J. Non-Cryst. Solid, 2000, 285, 210-215], and alumina[S. J. Teichner et al, Adv. Colloid Interface Sci. 1976, 5, 245]. Organic aerogels include, but are not limited to, urethane aerogels [G. Biesmans et al, 1998, 225, 36], resorcinol formaldehyde aerogels [R. W. Pekala, U.S. Pat. No. 4,873,218], and polyimide aerogels [W Rhine et. al, U.S. 2004132845]. Organic/inorganic hybrid aerogels are primarily ormosil (organically modified silica) aerogels [D. A. Loy et al, J. Non-Cryst. Solid, 1995, 186, 44]. The aerogels used in the current invention may belong to this category, in which the organic components are chemically bonded to the silica network.

Low-density aerogel materials (0.01-0.3 g/cc) are widely considered to be the best solid thermal insulators, better than the best rigid foams, and have thermal conductivity values of 12 mW/m-K and below at 37.8° C. and atmospheric pressure. Aerogels function as thermal insulators by minimizing conduction (low density, tortuous path for heat transfer through the solid nanostructure), convection (very small pore sizes minimize convection), and radiation (IR absorbing or scattering dopants are readily dispersed throughout the aerogel matrix). Aerogel materials also display many other interesting acoustic, optical, and chemical properties that make them useful in both consumer and industrial markets.

Aerogel particulate forms, especially spherically-shaped silica aerogel particles have been commercially manufactured over the past several decades and have been primarily focused on in the insulation markets. Silica aerogel monoliths have been known to exhibit poor mechanical properties such as fragility and brittleness which has hindered their success in sectors of the insulation market.

More recently, many investigators have attempted to extend aerogel applications into a much broader area. For instance, efforts focusing on converting fragile and loose aerogel beads into structural insulation components have been made where polymeric binders are used to bind loose beads together to form larger solid structures. A few notable examples are described as follow:

U.S. 2002/0025427 and U.S. 2003/0003284 describe aerogel composites in which silica aerogel particles were mixed with a commercially available polymeric binder such as Mowilith® or Mowital® and cured under compression at elevated temperatures (220° C.). However, they suffer from the fact that silica and binder compositions are different and as such may not bind intimately. The insulation panels prepared according to this approach have average thermal conductivity values of ˜45 mW/m-K and an average density of ˜0.25 g/cm³.

The following disclosures WO03064025, WO2003/097227, WO2003/0215640, U.S. 2004/0077738, U.S. 2005/025952 pertain to insulation panels that can be formed from a composite comprising hydrophobic silica aerogel particles. Both silica and carbon aerogel and xerogel particles are of concern to the aforementioned publication. A typical insulation panel described in this patent has a thermal conductivity of 0.187 Btu/hr ft °F., with an R-value of 0.026 hr ft² °F./Btu.

Despite such efforts, aerogel composites comprising organic-inorganic hybrid aerogel particulates and a binder material have not been addressed. Particularly where the hybrid materials are interlocked via their organic functionalities and via a binding matrix. The organic functionalities may be polymers or oligomers that span, thereby securing, two hybrid aerogel particles.

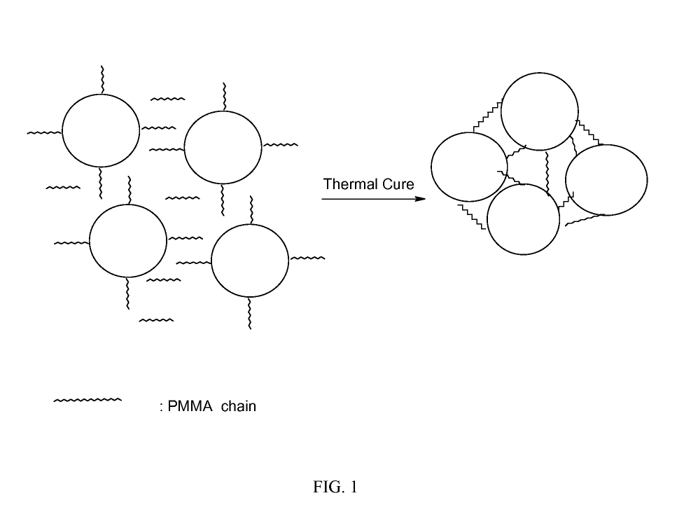

A method of preparing hybrid aerogel beads is described in U.S. provisional patent application number 60/619,506 which is incorporated by reference. The incorporation of organic components in silica aerogel beads that have latent reactivity (for example PMMA) opens an opportunity to perform chemical modifications of the beads in the post-production stage. For instance, the PMMA polymer incorporated in the hybrid silica/PMMA aerogel beads can react with a PMMA-based polymeric binder when heated to temperatures above about 80° C. The beads and binder can adopt a rigid form with the desired shape after thermal curing, as illustrated in FIG. 1.

Present embodiments present a further advancement on aerogel particle/polymeric binder composites. Unlike those described earlier, significantly lower thermal conductivity values (about 20 mW/mK) were found in the composite panels prepared according to the present embodiments. In a preferred embodiment, the thermal conductivity obtained may be less than about 50 mW/mK, preferably less than about 30 mW/mK and most preferably less than about 25 mW/mK. For example the PMMA/silica aerogel beads together with a PMMA-based binder present a highly effective form of aerogel particle composites with excellent mechanical and thermal properties.

### DETAILED DESCRIPTION OF THE INVENTION

The basic route for the formation of polymer/silica hybrid aerogel particles or beads is described in U.S. patent application Ser. No. 11/251,079. Polymers used in the preparation of polymer/silica hybrid aerogels include, but are not limited to, polyacrylates, polymethacrylate, polyether, polystyrenes, polyacrylonitriles, polyurethanes, polyamides, polyimides, polycyanurates, polyacrylamides, various epoxies, agar, agarose, and the like. The inorganic component of the of the hybrid particle can comprise metal oxides such as, but not limited to, silica, titania, zirconia, alumina, hafnia, yttria, ceria; and also carbide, nitrides and any combination of the preceeding. Silica precursors are preferred and in the preparation of the polymer/silica hybrid aerogels can be exemplified by, but not limited to, silicate esters and partially hydrolyzed silicate esters. Specific examples of silicate esters include tetraethoxysilane (TEOS), tetramethoxysilane (TMOS), and tetra-n-propoxysilane. A specific example of a partially hydrolyzed silicate ester, also preferred herein, is commercially available and known generically as polydiethoxysiloxane. Pre-polymerized silica precursors are especially preferred for the processing of gel materials described in this invention. The most suitable hydrolyzable polymer is alkoxysilyl-containing polymethacrylates; specific examples of such compounds include trimethoxysilyl-containing polymethylmethacrylate, triethoxysilyl-containing polymethylmethacrylate, trimethoxysilyl containing polybutylmethacrylate, triethoxysilyl containing polybutylmethacrylate. These trialkoxylsilyl-containing polymethacrylate polymers can be synthesized from a methacrylate monomer, together with trimethoxysilylpropylmethacrylate. The methacrylate monomer includes, but is not limited to, methylmethacrylate (referred to as MMA hereafter), ethylmethacrylate (referred to as EMA hereafter), butylmethacrylate (referred to as BMA hereafter), hydroxyethylmethacrylate (referred to as HEMA hereafter), hexafluorobutyl methacrylate (referred to as HFBMA hereafter), or mixtures thereof

The present embodiments provide an aerogel-based insulation structures comprising aerogel particles and an microemulsion binder composition. In the preferred embodiment, a trimethoxysilyl compound containing a polymethacrylate oligomer is co-condensed with a partially hydrolyzed silica alkoxide in an alcohol solution to form a hydrolyzed sol. Sols can further be doped with solids (including IR opacifiers, sintering retardants, microfibers, etc.) that influence the physical and mechanical properties of the gel product. Suitable amounts of such dopants typically range from 1-40% by weight of the finished composite, preferably 2-30% using the casting methods of this invention. IR opacifiers include, but are not limited to, B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide and any combination thereof. The hydrolyzed sol is then mixed with a catalyst and immediately dispensed into a flowing liquid medium that is non-miscible with the sol. This procedure can be carried out in a continuous manner. Both acid and base can be used as catalyst. Acid catalysts include HCl, H₂SO₄ and HF. Base catalysts include NaOH, KOH and NH₄OH. Silicone oil is the preferred flowing liquid medium but may be substituted with mineral oil.

Spherical sol droplets form in the silicone oil by virtue of the interphase tension. The sol droplets form hydrogel beads and rigidify themselves during their stay in the silicone oil. After surface trimethylsilylation, (which can be carried out before or after gelation) the solvent inside the hydrogel beads may be removed using supercritical extraction methods, preferably with supercritical CO₂, leading to the formation of PMMA/silica hybrid aerogel beads. Optionally, aging compounds such as HMDS can be applied to the gel beads prior to solvent removal (drying).

Methods of drying gels for generating aerogels or xerogels are well known. Kistler (J. Phys. Chem., 36, 1932, 52-64) describes a drying process where the gel solvent is maintained above its critical pressure and temperature. Due to the absence of any capillary forces, such supercritical drying maintains the structural integrity of the gel. U.S. Pat. No. 4,610,863 describes a process where the gel solvent is exchanged with liquid carbon dioxide and subsequently dried at conditions where carbon dioxide is in a supercritical state. Such conditions are milder than the one described by Kistler. U.S. Pat. No. 6,670,402 teaches drying via rapid solvent exchange of solvent inside wet gels using supercritical CO₂ by injecting supercritical, rather than liquid, CO₂ into an extractor that has been pre-heated and pre-pressurized to substantially supercritical conditions or above to produce aerogels. U.S. Pat. No. 5,962,539 describes a process for obtaining an aerogel from a polymeric material that is in the form a sol-gel in an organic solvent, by exchanging the organic solvent for a fluid having a critical temperature below a temperature of polymer decomposition, and supercritically drying the fluid/sol-gel. U.S. Pat. No. 6,315,971 discloses processes for producing gel compositions comprising: drying a wet gel comprising gel solids and a drying agent to remove the drying agent under drying conditions sufficient to minimize shrinkage of the gel during drying. Also, U.S. Pat. No. 5,420,168 describes a process whereby Resorcinol/Formaldehyde aerogels can be manufactured using a simple air drying procedure. U.S. Pat. No. 5,565,142 describes a process where the gel surface is modified such that it is more hydrophobic and stronger so that it can resist any collapse of the structure during ambient or subcritical drying. Surface modified gels are dried at ambient pressures or at pressures below the critical point (subcritical drying). Products obtained from such ambient pressure or subcritical drying are often referred to as xerogels

In an embodiment, aerogel particles used in the embodiment of the present invention may be larger than 0.1 mm and preferably larger than 0.5 mm and most preferably larger than 1 mm. In an alternate embodiment, aerogel particles may be less than 0.1 mm in which case the amount of binder used in the composite may vary providing various product properties.

The polymeric binders used in the present invention are preferably in the same family of compounds as the organic portion of the aerogel particles. More Preferably in the acrylate family of nanoparticulate polymers. Examples include, polymethylmethacrylate, polybutylmethacrylate, polyethylmethacrylate, polypropylmethacrylate, poly(2-hydroxyethyl-methacrylate), poly(2-hydroxypropylmethacrylate), poly(hexafluorobutyl-methacrylate), poly(hexafluoroisopropylmethacrylate), polydimethylsiloxane, polyoxyalkylene, polyurea, polybutadiene, polyoxypropylene, polyoxypropylene-copolyoxyethylene and mixtures thereof. The preferred binders for this invention are PMMA based microemulsions. The PMMA microemulsion binder can be prepared by a seeded emulsion polymerization method. This technique allows one to create polymer particles in a well defined way regarding the particle size and intersection morphology. Using MMA and one or several other acrylic monomers at different stages in the polymerization process, gives one the ability to achieve complex particle morphologies, in terms of phase distribution inside the polymer particles as well as on the surface of the polymer particles. Two-stage polymerization is carried out in this case. The first stage polymerization is carried out in an aqueous reaction medium with a surfactant, a catalyst, MMA and one or several acrylic monomers other than MMA, wherein the sodium dodecyl sulfate is the preferred surfactant and sodium persulfate is the preferred catalyst. The second acrylic monomer includes but is not limited to butyl methacrylate, hydroxylethyl arylate, methacrylate acid, propyl methacrylate, styrene, butyl acrylate, acrylic acid, ethylhexyl acrylate, wherein butyl acrylate is preferred.

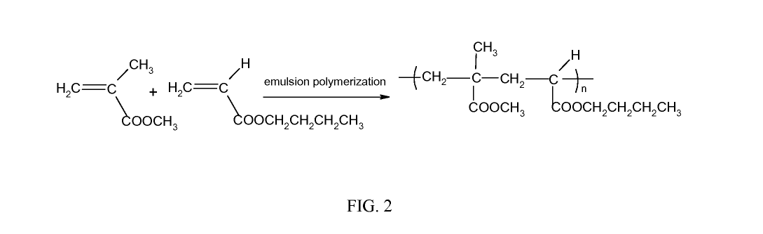

The reaction mechanism is illustrated in FIG. 2. Upon completion of the first stage polymerization, additional MMA and the second acrylic monomer is added into the reaction system and the polymer particles are grown to a size of around 50 nm in diameter.

When the resulting PMMA/PBA microemulsion is mixed with PMMA/silica aerogel beads, the smaller polymer particles (microemulsion) will stick on the surface of the much larger aerogel beads. The polymers are not likely to penetrate into the inner section of the aerogel through its nanoporous structure due to the polymer size. The microemulsion polymers are similar to or larger than the size of the pores in the aerogel. The aerogel bead/binder composites derived from PMMA/PBA emulsions have significantly better workability than those derived from other polymeric binders making it easier to fill molds having complex geometries, such as honeycomb cells, pipe line components, or fuel cell components. The workability of PMMA/PBA emulsion/aerogel composites allows it to be applied in both spread and spray form. The ability to turn it into a spray form provides an advantage in large-scale applications. The aerogel/binder ratio is ranged from 0.2 to 5, preferably 0.5 to 2; depending on the end-use application. Water can be used, optionally, in the aerogel/binder composite to achieve a desirable workability as needed for the application requirements. The aerogel bead/binder composites turn into a rigid structural component after they are cured at elevated temperatures, illustrated in FIG. 1, wherein the elevated temperature is between 40° and 100° C., preferably between 80° C. and 90° C., wherein the curing time is between 4 h to 400 h, preferably between 5 h to 12 h.

In a preferred embodiment, these composites give rise to insulation structures that can be used in various sizes and shapes. The resulting PMMA/silica aerogel bead/multi-component PMMA binder composite panels show good flexural resistant properties. The improvement in mechanical properties for this type of aerogel composite is achieved without sacrificing other attractive inherent properties of the aerogel, including low density and low thermal conductivity.

It is noted here that when cured by thermal or other means, a component in the hybrid aerogel, preferably a component that is of the same family as that of a component of the binder forms a covalent bond with at least a component of the binder. In a non limiting example, if polymethyl methacrylate-silica hybrid aerogel and a methcrylate binder are used, then during the curing process or by any other known techniques recognized in the art, at least one covalent bond may be formed between the aerogels and the binder. Such bonds strengthen the composition as such and provide for strong binding of particulates to the binder.

In several embodiments, “same family” is referenced in a broad sense to refer to a group of compounds having at least one common functional group and in a narrow sense to refer to compounds with similar structure and are differed only by attachment for few additional groups. For example, methcrylate, methyl methacrylate, butyl acrylate are considered members of acrylate family in the narrow sense.

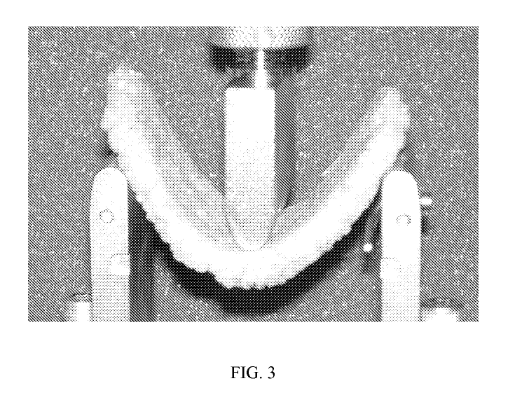

In another embodiment, flexible structures can be made using the composites of different embodiments. Amount of beads or particles and the binder used in making a structure may be adjusted as well as the nature of the binder to make the structure to be flexible. A 1 cm thick panel can bend up to a 90° angle without breaking, as illustrated in FIG. 3.

In another embodiment, the composites may be bent up to 90° angle without fracture and preferably bent up to 45° angle without fracture.

The thermal conductivity values of the aerogel bead/binder composites described in the following examples were similar to the corresponding loose hybrid aerogel beads, having values in the range of 20-25 mW/m-K. Thermal performance in this range shows a significant improvement over the aerogel bead/binder composites described in other works previously described. Multi-component PMMA emulsions appear to cause minimal reduction in the thermal insulation performance of the resulting aerogel composites. The density of the resulting aerogel composite is typically in the range of about 0.01 to about 0.4 g/cm³, preferably in the range of about 0.05 g/cm³ to about 0.3 g/cm³ and most preferably in the range of about 0.1 g/cm³ to about 0.2 g/cm³which is similar to other typical aerogel based products. The tensile strength of the composites disclosed herein may be in the range of about 5 psi to about 500 psi and preferably at least about 10 psi and most preferably about 25 psi.

Thermal conductivity values in various embodiments have been measured either by a guarded hot plate method or heat flow meter method and may conform to ASTM C 177 or ASTM C-518.

Curing as used in the context of the embodiments refer to curing of a resin comprising monomers, oligomers or polymers. In some embodiments it may refer to the act of a polymerization, a reaction, a bond formation, a cross linking and equivalent activities. Curing may be purely chemical in nature or through imparting energy. Energy may be imparted by way of heat addition, UV exposure or any other wave exposure like micro waves.

In yet another embodiment, discrete fibers, fibrous mat, fibrous battings, lofty battings can be combined with the composites of the preceding embodiments to provide reinforced structures. Additionally, fibers can be added to the particles there by making fiber reinforced particles and such particles may be used in any of th embodiments.

### EXAMPLES

The following non-limiting examples are provided so that one skilled in the art may more readily understand the invention. In the examples weights are expressed as grams (g). ter-butyl peroxy-2-ethyl hexanoate was obtained from Degussa; cross-linker TMSPM was obtained from Ashland Chemicals as Dow Corning Z6030 silane. All of the other chemicals used in the examples were purchased from Aldrich.

### Example 1

This example illustrates the formation of 1 to 3 mm diameter size PMMA/silica aerogel beads with 15% loading of PMMA. Ter-butyl peroxy-2-ethyl hexanoate (0.90 g) was added to a mixture of MMA (40 g), TMSPM (24.8 g) and methanol (18.3 g), followed by vigorous stirring at 70-80° C. for 0.5 h. Trimethoxysilyl-containing polymethacrylate oligomer was obtained as a viscous liquid in a concentrated ethanol solution.

Trimethoxylsilyl-containing polymethacrylate oligomer (41.16 g) was mixed with silica precursor (829.6 g), ethanol (207.9 g), water (93.8 g) and 0.1 M aqueous HC1 (56.1 g) for 1 hour at ambient conditions. The hydrolyzed sol was then charged into a pressure container. Aqueous base (28-30%; 34.7 g) was mixed with ethanol (261.3 g) and water (330.7 g) for 10 minutes to form the catalyst. The catalyst was then charged into another pressure container. The sol and catalyst were mixed together in a 2 to 1 ratio and dispersed by a nozzle. Sol droplets formed as they fell into flowing silicone oil. The resulting sol droplets flow slowly with the silicone oil toward the end of the vessel and downward into the collection bag as beads. Collected beads can be removed periodically. After removing the excess amount of silicone oil, the bags of hydrogel beads are made to go through a silylation step and dried by CO₂ supercritical extraction. The obtained PMMA/silica aerogel beads have a typical diameter of 1-3 mm, packing density of 0.123 g/cm³ and thermal conductivity of 21.2 mW/m-K. The maximum compression failure load for representative hybrid aerogel beads (2 mm diameter) is 0.93 kg.

### Example 2

This example illustrates the formation of small, opacified PMMA/silica aerogel beads with 5 weight % loading of carbon black. Silica precursor (6.01 kg) was mixed with 303 g of trimethylsilyl-containing polymethacrylate oligomer solution, ethanol (9.78 kg) and 1.57 kg of water for 1 hour at ambient conditions. The mixture was charged into a pressure container as hydrolyzed sol. Aqueous base (28-30%; 6.75 kg) was mixed with ethanol (1.98 kg) and 130 g Alcoblack® for 10 minutes. This mixture was charged into another pressure container as catalyst. The sol and catalyst were mixed together in a 2 to 1 ratio by a nozzle and sol droplets formed as they fell into the flowing silicone oil. A stream of compressed air was ejected along the sol droplets, generating a sol spray before entering the silicone oil. The resulting sol micro droplets flow slowly with the silicone oil toward the end of the vessel and downward into the collection bag. Collected beads can be removed periodically.

After removing the excess amount of silicone oil, the bags of hydrogel beads went through a silylation step and were dried by CO₂ supercritical extraction. The obtained opacified PMMA/silica aerogel micro beads have a typical diameter of 0.1-0.3 mm, a packing density of 0.06 g/cm³ and thermal conductivity of 16.7 mW/m-K.

### Example 3

This example illustrates the formation of PMMA based multi-component microemulsions and involves two stages.

The first stage pre-emulsion was prepared from a mixture of water (15.2 g), sodium dodecyl sulfate aqueous solution (15 wt %, 6.3 g), acrylic acid (0.368 g), MMA (12.5 g), butylacrylate (25.63 g), sodium pyrophosphate aqueous solution (0.2 wt %, 3.3 g) and sodium persulfate aqueous solution (0.545 mM, 3.73 g). In which sodium dodecyl sulfate is the surfactant, sodium pyrophosphate is the buffer solution and sodium persulfate is the catalyst. This was mixed at 90° C. for 20 min.

The second stage microemulsion was prepared as follows: a mixture consisting water (5.8 g), sodium dodecyl sulfate aqueous solution (15 wt %, 5.0 g), acrylic acid (0.677 g), MMA (37.5 g) and sodium persulfate aqueous solution (0.545 mM, 1.4 g) was added into the stage one solution and mixed at 55° C. for 10 minutes. Upon cooling to ambient temperature the resulting microemulsion was used as the binder in the following example.

### Example 4

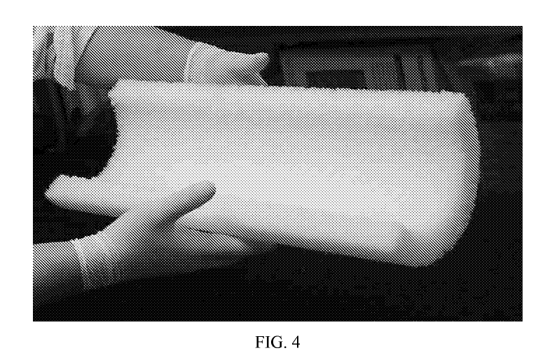

This example illustrates the formation of rigid insulation panels from unopacified PMMA/silica hybrid aerogel beads (Example 1) and a PMMA based multi-component microemulsion (Example 3). The beads prepared in Example 1 (1500 g) were mixed with the binder prepared in Example 3 (1500 g) for 5 minutes and cast into various molds with different sizes and shapes. Rigid components were formed after curing at 55° C. for 24 h. A clamshell component of this example is shown FIG. 4. Density and thermal conductivity measurements were obtained on 0.5″ thick 4″ by 4″ coupons. The average thermal conductivity of the resulting insulation panels is 23.5 mW/m-K, and the average density of the insulation panels is 0.155 g/cm³. As illustrated in FIG. 3, the insulation panels of Example 4 were unable to break by flexural force. Tensile measurements (ASTM 5034) show a 25 psi tensile strength at the break point for the panels in this example

### Example 5

This example illustrates the formation of rigid insulation panels from opacified PMMA/silica hybrid aerogel beads (Example 2) and a PMMA based multi-component microemulsion (Example 3). Example 2 (150 g) was mixed with Example 3 (150 g) and water (225 g) for 5 minutes and cast into various molds with different sizes and shapes.

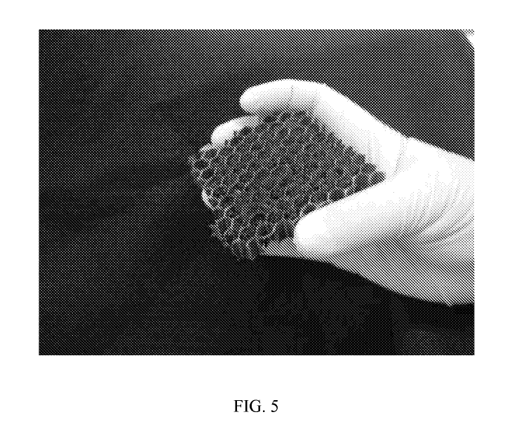

Rigid components were formed after curing at 55° C. for 24 h. A honeycomb component of this example is shown in FIG. 5. Density and thermal conductivity measurements were obtained on 0.5″ thick 4″ by 4″ coupons. The average thermal conductivity of the resulting insulation panels is 21.3 mW/m-K, and the average density of the insulation panel is 0.100 g/cm³.

In the present embodiments, the aerogel matrix can comprise metal oxides such as silica, alumina, titania, zirconia, hafnia, yttria, vanadia or carbides, nitrides and the like, with silica being the preferred matrix material.

What is claimed is:

1. A composition comprising organic-inorganic hybrid aerogel particulates and a binder, wherein said binder comprises components that are of same family as at least an organic component of said hybrid aerogel particulates.

2. The composition of claim 1, wherein the at least one component of said aerogel particulates forms at least one covalent bond with said binder.

3. The composition of claim 1 wherein the binder comprises polymers, monomers, oligomers or a combination thereof.

4. The composition of claim 1 wherein said binder comprises a surfactant.

5. The composition of claim 1 wherein said binder is an emulsion.

6. The composition of claim 3 wherein said polymer is polymethylmethacrylate, polybutylmethacrylate, polyethylmethacrylate, polypropylmethacrylate, poly(2-hydroxyethyl-methacrylate), poly(2-hydroxypropylmethacrylate), poly(hexafluorobutyl-methacrylate), poly(hexafluoroisopropylmethacrylate), polydimethylsiloxane, polyoxyalkylene, polyurea, polybutadiene, polyurethane polyoxypropylene, polyoxypropylene-copolyoxyethylene or mixtures thereof

7. The composition of claim 2 wherein the covalent bond between the aerogel particles and the binder comprises an acrylic moiety, siloxane moiety, urea moiety, ester moiety or a combination thereof.

8. The composition of claim 5 wherein the covalent bond comprises a PMMA chain.

9. The composition of claim 1 wherein the aerogel particulate sizes are greater than about 0.5 mm.

10. The composition of claim 1 wherein the aerogel particulate sizes are less than about 0.5 mm.

11. The composition of claim 1 wherein the inorganic component of the aerogel is a metal oxide.

12. The composition of claim 1 wherein the inorganic component of the aerogel is selected from the group consisting of silica, titania, zirconia, alumina, hafnia, yttria, ceria, carbides, nitrides and any combination thereof

13. The composition of claim 2 wherein a trialkoxysilyl group is attached to the organic component of hybrid aerogel.

14. The composition of claim 1 wherein the binder is a nanoparticulate polymer.

15. The composition of claim 1 having a thermal conductivity of less than about 30 mW/mK.

16. The composition of claim 13 having a thermal conductivity of less than about 19 mW/mK.

17. The composition of claim 1 having a density less than about 0.3 g/cm³, optionally less than about 0.15 g/cm³.

18. The composition of claim 1 further comprising infrared opacifiers, infrared reflectors, infrared absorbers, fire retardants, antimicrobial agents, antifungal agents, pigments, catalysts and smoke suppressors.

19. The composition of claim 1 further comprising fibers, optionally in the form of chopped fibers, batting, or lofty batting.

20. A shaped article comprising the composition of claim 1 optionally, in the general shape of clamshell, cylindrical, semicylindrical, semispherical or other complex geometry.

21. The article of claim 20 wherein the insulation article can be bent up to 45 degrees without fracture.

22. The article of claim 20 wherein the insulation article can be bent up to 90 degrees without fracture.

23. The article of claim 20 having a tensile strength of at least 25 psi.

24. A composition comprising organic-inorganic hybrid aerogel particulates and a binder, wherein at least one component of said aerogel particulates forms at least one covalent bond with said binder.

25. A method of manufacture of an article comprising the steps of:
combining organic-inorganic hybrid aerogel particles with a binder; and
curing said binder thereby forming an article, wherein at least one component of said aerogel particles forms at least one covalent bond with said binder.

26. The method of manufacture of an article comprising the steps of:
combining organic-inorganic hybrid aerogel particles with a binder; and
curing said binder thereby forming an article, wherein said binder comprises components that are of the same family as at least one organic component of said hybrid aerogel particulates.

27. The method of claim 25 wherein said binder comprises components that are of the same family as at least one organic component of said hybrid aerogel particles.

28. The method of claim 25 wherein at least one component of said aerogel particles forms at least one covalent bond with said binder.

29. The method of claim 25 wherein said binder is an emulsion, a suspension or a solution.

30. The method of claim 25 wherein the binder comprises polymers, monomers, oligomers or combinations thereof.

31. The method of claim 25 wherein the binder comprises a polymethylmethacrylate, polybutylmethacrylate, polyethylmethacrylate, polypropylmethacrylate, poly(2-hydroxyethyl-methacrylate), poly(2-hydroxypropylmethacrylate), poly(hexafluorobutyl-methacrylate), poly(hexafluoroisopropylmethacrylate), polydimethylsiloxane, polyoxyalkylene, polyurea, polybutadiene, polyoxypropylene, polyoxypropylene-copolyoxyethylene or mixtures thereof

32. The method of claim 25 wherein said covalent bond comprises an acrylic moiety, siloxane moiety, urea moiety, ester moiety or a combination thereof.

33. The method of claim 25 wherein the covalent bond comprises a PMMA chain.

34. The method of claim 25 wherein the aerogel particulate sizes are greater than about 0.5 mm.

35. The method of claim 25 wherein the aerogel particulate sizes are less than about 0.5 mm.

36. The method of claim 25 wherein the inorganic component of the aerogel is a metal oxide.

37. The method of claim 25 wherein the inorganic component of the aerogel is selected from the group consisting of silica, titania, zirconia, alumina, hafnia, yttria, ceria, carbides, nitrides or any combination thereof

38. The method of claim 25 wherein a trialkoxysilyl group is attached to organic component of said hybrid aerogel.

39. The method of claim 25 wherein said binder is a nanoparticulate polymer.

40. The method of claim 25 wherein the article has a thermal conductivity of less than about 30 mW/mK.

41. The method of claim 25 wherein the article has a thermal conductivity of less than about 19 mW/mK.

42. The method of claim 25 wherein the article has a density less than about 0.3 g/cm³, optionally less than about 0.15 g/cm³.

43. The method of claim 25 further comprising the step of adding infrared opacifiers, infrared reflectors, infrared absorbers, fire retardants, antimicrobial agents, antifungal agents, pigments, catalysts or smoke suppressors to said article.

44. The method of claim 25 further adding fibers, optionally in the form of chopped fibers, batting, or lofty batting.

45. The method of claim 25 wherein said curing is performed at an elevated temperature.

46. The method of claim 45 wherein said elevated temperature is between 40° C. and 100° C., preferably between 50° and 60° C.

47. A method of applying the composition of claim 1 on to a surface by spraying said composition onto said surface.

48. The method of claim 25 further comprising the step of forming the mixture into a complex geometry.

49. The method of claim 58 wherein the forming is performed by casting.
